(19) United States
(12) Patent Application Publication
(10) Pub. No.: US 2015/0346577 A1
(43) Pub. Date: Dec. 3, 2015

(54) REFLECTIVE DISPLAY DEVICE

(71) Applicant: NANOBRICK CO., LTD., Suwon-si (KR)

(72) Inventors: Dong Jin LEE, Suwon-si (KR); Jae Hyun JOO, Suwon-si (KR)

(21) Appl. No.: 14/722,506

(22) Filed: May 27, 2015

(30) Foreign Application Priority Data
May 28, 2014 (KR) 10-2014-0064740

(51) Int. Cl. G02F 1/167; G02F 1/1333

(52) U.S. Cl. CPC G02F 1/167; G02F 1/133348

(57) ABSTRACT

Provided is a reflective display device, including: a display part including first particles having an electric charge and a first color, capsules having a second color, and a light transmissive fluid in which the first particles and the capsules are dispersed; an electric field applicator for applying an electric field to the display part; and a controller for controlling the color displayed by the display part by adjusting at least one of the intensity and the direction of the electric field applied to the display part, wherein the position of the capsules in the display part is passively determined depending on the position of the first particles that are moved by the electric field.

### BACKGROUND

1. Field

The present invention relates to a reflective display device. More specifically, the present invention relates to a reflective display device, including: a display part including first particles having an electric charge and a first color, capsules having a second color, and a light transmissive fluid in which the first particles and the capsules are dispersed; an electric field applicator for applying an electric field to the display part; and a controller for controlling the color displayed by the display part by adjusting at least one of the intensity and the direction of the electric field applied to the display part, wherein the position of the capsules in the display part is passively determined depending on the position of the first particles that are moved by the electric field.

2. Description of the Prior Art

Reflective display devices have advantages, such as excellent visibility in outdoor environments and superior low-power characteristics, and thus have been widely used in various fields, such as electronic books, mobile displays, and outdoor displays.

An electrophoretic display (EPD) technology may be a representative example of reflective display devices. The electrophoretic display (EPD) technology displays information by controlling the position of charged particles using electrophoresis while the charged particles are dispersed in a dielectric material.

FIG. 1 illustratively shows a reflective display device according to a prior art.

According to an electrophoretic display technology introduced in the prior art, an electric field is applied to a display part that contains a fluid, in which charged particles are dispersed, thereby moving the particles in the display part. Here, when the particles move to an upper portion of the display part, the inherent color of the particles may be displayed, and when the particles move to a lower portion of the display part, the inherent color of the fluid may be displayed.

According to the above prior art, it is advantageous that the manufacturing process is relatively simple since it is not necessary to precisely control characteristics such as the quantity of electric charges of the particles, the mixing ratio of the particles and the fluid, etc. On the other hand, it is problematic that the display performance deteriorates due to the precipitation of dyes contained in the fluid and the prior art has limitations that the reflectivity is lowered or the color characteristics are degraded since the inherent color of the fluid is displayed to some degree due to the fluid exposed through pores between the particles even when the inherent color of the particles is supposed to be mainly displayed as the particles move to an upper portion of the display part.

### SUMMARY

The present invention has been made to solve the above-mentioned problems of the prior art, and an aspect of the present invention is to provide a reflective display device, including: a display part including first particles having an electric charge and a first color, capsules having a second color, and a light transmissive fluid in which the first particles and the capsules are dispersed; an electric field applicator for applying an electric field to the display part; and a controller for controlling the color displayed by the display part by adjusting at least one of the intensity and the direction of the electric field applied to the display part, wherein the position of the capsules in the display part is passively determined depending on the position of the first particles that are moved by the electric field.

The capsules may include a dye having the second color.

The capsules may include at least one of a fluorescent material and a glow-in-the-dark material, which are responsive to light emitted from the outside.

The capsules may include at least one of a dye, a fluorescent material, a glow-in-the-dark material, and a thermochromic material, and at least one of an electric field, light, and heat energy that are applied to the display part may be adjusted to display a fourth color that is a mixture of at least two of the first color, the second color, and the third color.

The capsules may include a thermochromic material whose color changes depending on the temperature.

The color displayed by the display part may change when the temperature of the thermochromic material changes.

The display part may further include second particles having a third color and an electric charge of opposite polarity to the first particles.

According to the embodiments of the present invention, a reflective display device having a simple structure where particles with an inherent color and capsules with an inherent color are dispersed in a transparent fluid can be realized and the deterioration in light characteristics can be prevented.

Furthermore, according to the embodiments of the present invention, even when the dye inside the capsules is precipitated due to operating environments (e.g., temperature or the like) of the reflective display device, the precipitated dye remains only within the capsules and does not affect the electrophoretic characteristics of the particles. Therefore, the durability of the reflective display device can be improved.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustratively shows a reflective display device according to the prior art;

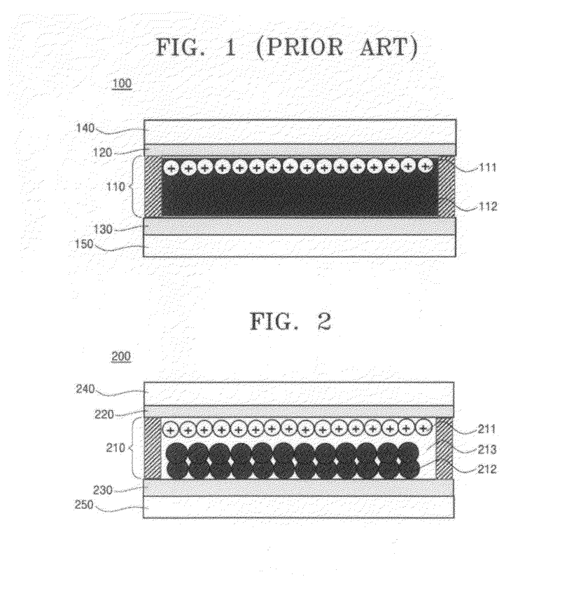

FIGS. 2 and 3 illustratively show a reflective display device according to an embodiment of the present invention;

FIG. 4 illustratively shows a structure in which two or more kinds of particles are contained in a display part of a reflective display device according to an embodiment of the present invention;

FIG. 5 illustratively shows a structure in which a thermochromic material is contained in capsules inside a display part of a reflective display device according to an embodiment of the present invention; and

FIGS. 6 and 7 illustratively show experimental examples of a reflective display device according to an embodiment of the present invention.

### DETAILED DESCRIPTION

Hereinafter, specific embodiments of the present disclosure which may be carried out will be illustratively described in detail with reference to the accompanying drawings. The embodiments will be sufficiently described in detail such that those skilled in the art may carry out the present disclosure. It should be understood that although various embodiments of the present invention are different from each other, they need not be mutually exclusive. For example, with relation to an embodiment, specific forms, structures, and characteristics described herein may be implemented through another embodiment without departing from the spirit and scope of the present disclosure. Moreover, it should be understood that locations or arrangements of separate elements within the disclosed embodiments can be changed without departing from the spirit and scope of the present invention. Accordingly, the detailed descriptions which will be given below are not intended to be restrictive, and the scope of the present disclosure, if properly described, should be limited only by the accompanying claims and equivalents thereof. Similar reference numerals shown in the drawings denote members performing an identical or similar function in several aspects.

Hereinafter, embodiments of the present invention will be described below in detail with reference to the accompanying drawings, so that those skilled in the art can easily carry out the present invention.

[Reflective Display Device]

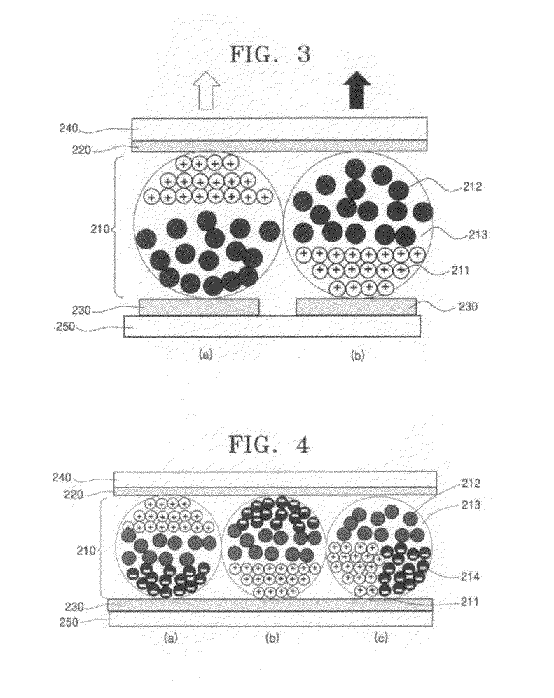

FIGS. 2 and 3 illustratively show a reflective display device according to an embodiment of the present invention.

Referring to FIG. 2, a reflective display device 200 according to an embodiment of the present invention may include a display part 210, an upper electrode 220, a lower electrode 230, an upper substrate 240, and a lower substrate 250. Here, the display part 210 may include first particles 211 having an electric charge and a first color, capsules 212 having a second color, and a light transmissive fluid 213 in which the first particles 211 and the capsules 212 are dispersed.

In addition, the reflective display device 200 according to an embodiment of the present invention may further include a controller (not shown) that adjusts the color displayed from the display part 210 by controlling the position of the first particles in the display part 210 by controlling at least one of the intensity and the direction of an electric field that is applied to the display part 210 via the upper electrode 220 and the lower electrode 230.

Meanwhile, according to an embodiment of the present invention, the capsules 212 may include a dye having the second color as an inherent color thereof. In addition, according to an embodiment of the present invention, the capsules 212 may include a thermochromic material whose color changes depending on the temperature.

Next, referring to FIG. 3, the position of the capsules 212 in the display part 210 of the reflective display device 200 according to an embodiment of the present invention may be passively determined depending on the position of the first particles 211 that are moved by an electric field (that is, electrophoresed) in the display part 210. For example, when the first particles 211 are moved by an electric field to converge on an upper portion of the display part 210 (that is, a portion close to a display surface), the capsules 212 may be positioned at a portion where the first particles 211 are not positioned, that is, a lower portion of the display part 210. Therefore, the color of the first particles 211 may be dominantly displayed by the display part 210 (see (a) of FIG. 3). On the contrary, when the first particles 211 are moved by an electric field to converge on a lower portion of the display part 210 (that is, a portion far away from the display surface), the capsules 212 may be positioned at a portion where the first particles 211 are not positioned, that is, an upper portion of the display part 210. Therefore, the color of the capsules 212 may be dominantly displayed by the display part 210 (see (b) of FIG. 3).

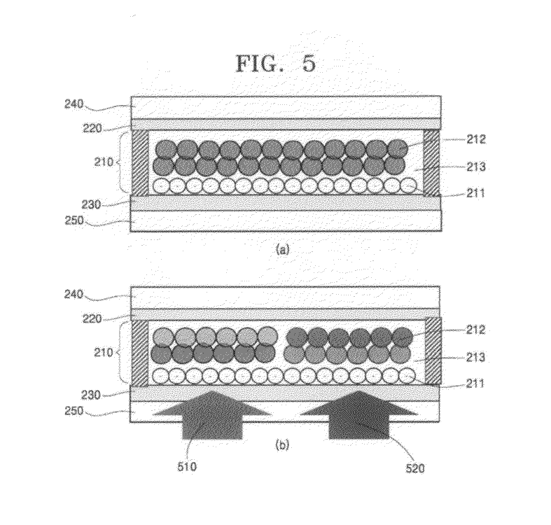

FIG. 4 illustratively shows a structure in which two or more kinds of particles are contained in a display part of a reflective display device according to an embodiment of the present invention.

Referring to FIG. 4, a display part 210 of a reflective display device 200 according to an embodiment of the present invention may include first particles 211 having an electric charge and a first color, capsules 212 having a second color, and a light transmissive fluid 213, in which the first particles 211 and the capsules 212 are dispersed, and may further include second particles 214 having a third color and an electric charge of opposite polarity to the first particles.

Therefore, according to an embodiment of the present invention, as shown in FIG. 4, as the first particles 211 and the second particles 214 are moved by an electric field, the first particles 211 converge on an upper portion of the display part 210 (that is, a portion close to a display surface), the second particles 214 converge on a lower portion of the display part 210 (that is, a portion far away from the display surface) and the capsules 212 may be positioned at a portion where the first particles 211 or the second particles 214 are not positioned, that is, a middle portion of the display part 210. Therefore, the color of the first particles 211 may be dominantly displayed by the display part 210 (see (a) of FIG. 4) Next, as the first particles 211 and the second particles 214 are moved by an electric field in a direction opposite to the electric field applied as shown in (a) of FIG. 4, the first particles 211 converge on the lower portion of the display part 210 (that is, a portion far away from the display surface), the second particles 214 converge on the upper portion of the display part 210 (that is, a portion close to the display surface) and the capsules 212 may be positioned in a portion where the first particles 211 or the second particles 214 are not positioned, that is, the middle portion of the display part 210. Therefore, the third color of the second particles 214 may be dominantly displayed by the display part 210 (see (b) of FIG. 4). Next, as an electric field having a particular pattern is applied, both the first particles 211 and the second particles 214 converge on the lower portion of the display part 210 (that is, a portion far away from the display surface) and the capsules 212 may be positioned at the upper portion of the display part 210 (that is, a portion close to the display surface). Therefore, the second color of the capsules 212 may be dominantly displayed by the display part 210 (see (c) of FIG. 4).

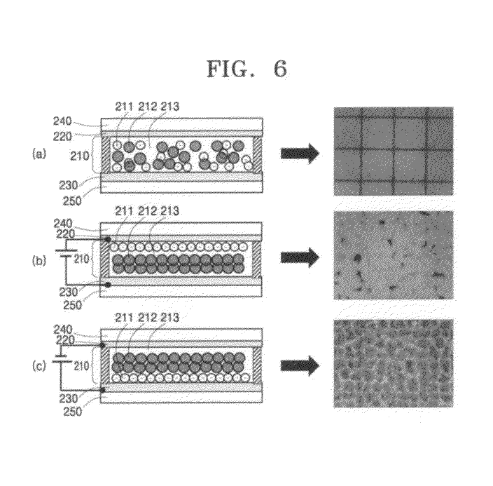

FIG. 5 illustratively shows a structure in which a thermochromic material is included in capsules inside a display part of a reflective display device according to an embodiment of the present invention.

Referring to FIG. 5, as an electric field with a predetermined direction and intensity is applied, the first particles 211 converge on a lower portion of the display part 210 (that is, a portion far away from the display surface) and the capsules 212 may be positioned at an upper portion of the display part 210 (that is, a portion close to the display surface). Therefore, the inherent color of the capsules 212 may be dominantly displayed by the display part 210 (see (a) of FIG. 5). In this state, the color displayed by the display part 210 may be determined depending on the color of the thermochromic material included in the capsules 212. According to an embodiment of the present invention, heat energy from the outside may be blocked or applied to the display part 210, to change the temperature of the thermochromic material in the capsules, thereby changing the color of the capsules 212, and further the color displayed by the display part 210 (see (b) of FIG. 5).

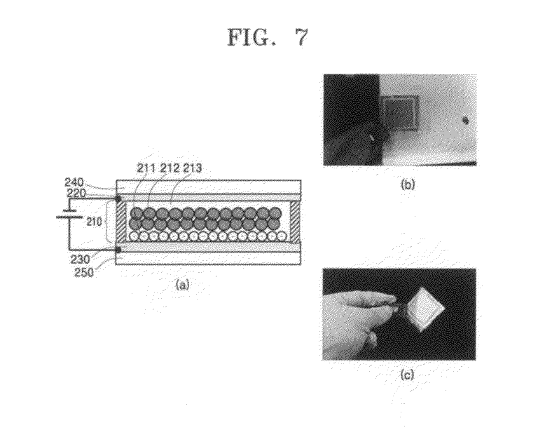

FIGS. 6 and 7 illustratively show experimental examples of a reflective display device according to an embodiment of the present invention.

First, referring to FIG. 6, it can be confirmed that, when no electric field is applied to the display part 210, the first particles 211 and the capsules 212 maintain the state of being irregularly dispersed in the fluid 213 and therefore a mixture of the inherent color (i.e., white) of the first particles 211 and the inherent color (i.e., red) of the capsules 212 may be displayed (see (a) of FIG. 6). Furthermore, it can be confirmed that, when an electric field is applied to the display part 210, the first particles 211 converge on an upper portion of the display part 210 and the capsules 212 are moved to a lower portion of the display part 210 and therefore the inherent color (i.e., white) of the first particles 211 is dominantly displayed by the display part 210 (see (b) of FIG. 6). Furthermore, it can be confirmed that, when an electric field in an opposite direction is applied to the display part 210, the first particles 211 converge on the lower portion of the display part 210 and the capsules 212 are moved to the upper portion of the display part 210 and therefore the inherent color (i.e., red) of the capsules 212 is dominantly displayed by the display part 210 (see (c) of FIG. 6).

Next, referring to FIG. 7, as an electric field with a predetermined direction and intensity is applied to the display part 210, the first particles 211 converge on a lower portion of the display part 210 and the capsules 212 are moved to an upper portion of the display part 210. Therefore, it can be confirmed that the color displayed by the display part 210 may be changed (see (b) and (c) of FIG. 7) by changing the temperature of the thermochromic material included in the capsules 212 with the color of the capsules 212 being dominantly displayed by the display part 210 (see (a) of FIG. 7).

As described above, although the present invention has been described through the specific matters such as detailed elements, the limited embodiments, and the drawings, they are provided to help overall comprehension of the present invention, and the present invention is not limited to the above-described embodiments. It is obvious to those skilled in the art to which the present invention pertains that various changes and modifications can be made from such descriptions as described above.

Accordingly, the spirit and scope of the present invention should not be limited or determined by the above-described embodiments, and it should be noted that not only the claims which will be described below but also their equivalents fall within the spirit and scope of the present invention.

What is claimed is:

1. A reflective display device, comprising:
a display part including first particles having an electric charge and a first color, capsules having a second color, and a light transmissive fluid in which the first particles and the capsules are dispersed;
an electric field applicator for applying an electric field to the display part; and
a controller for controlling the color displayed by the display part by adjusting at least one of the intensity and the direction of the electric field applied to the display part,
wherein the position of the capsules in the display part is passively determined depending on the position of the first particles that are moved by the electric field.

2. The reflective display device of claim 1, wherein the capsules include a dye having the second color.

3. The reflective display device of claim 1, wherein the capsules include at least one of a fluorescent material and a glow-in-the-dark material, which are responsive to light emitted from the outside.

4. The reflective display device of claim 1, wherein the capsules include a thermochromic material whose color changes depending on the temperature.

5. The reflective display device of claim 4, wherein the color displayed by the display part changes when the temperature of the thermochromic material changes.

6. The reflective display device of claim 1, wherein the display part further includes second particles having a third color and an electric charge of opposite polarity to the first particles.

7. The reflective display device of claim 6, wherein the capsules include at least one of a dye, a fluorescent material, a glow-in-the-dark material, and a thermochromic material, and
wherein at least one of an electric field, light, and heat energy that are applied to the display part is adjusted to display a fourth color that is a mixture of at least two of the first color, the second color, and the third color.
